(19) United States
(12) Patent Application Publication
(10) Pub. No.: US 2025/0109996 A1
(43) Pub. Date: Apr. 3, 2025

(54) A SURFACE COVERING DEVICE AND METHOD THEREOF

(71) Applicant: TECHNTILE PTE. LTD., Singapore (SG)

(72) Inventors: Eswaran S/O SARAVANAN, Singapore (SG); Palaniappan Saravanan Sundar VIKNESH, Singapore (SG)

(21) Appl. No.: 18/851,094

(22) PCT Filed: Apr. 3, 2023
(86) PCT No.: PCT/SG2023/050223

§ 371 Date: Sep. 26, 2024

(51) Int. Cl. G01L 1/14; G01J 5/00; G01J 5/02; G01J 5/04; G01J 5/34; G16Y 40/10; G16Y 40/20; H04Q 9/00

(52) U.S. Cl. CPC G01L 1/146; G01J 5/0025; G01J 5/025; G01J 5/026; G01J 5/041; G01J 5/34; G16Y 40/10; G16Y 40/20; G01J 2005/345; H04Q 9/00; H04Q 2209/47

(57) ABSTRACT

The present invention discloses a surface covering device comprising a tile, a base assembly, a plurality of tile connectors located between the tile and the base assembly for releasably connecting the tile to the base assembly, at least one capacitive sensor located on the tile, wherein the capacitive sensor is configured to detect changes in capacitive data indicative of the presence of activity within a predetermined range of the capacitive sensor; an infrared sensor configured to receive infrared data; a capacitive controller communicatively coupled to an infrared controller configured for receiving the capacitive data and the infrared data from the capacitive sensor and infrared sensor respectively; a mesh controller configured to receive the capacitive data and the infrared data from the capacitive controller and infrared controller respectively, and a wireless transceiver in data communication with the capacitive controller and the infrared controller, wherein the wireless transceiver is configured to transmit the capacitive data and the infrared data to a data analysis server, wherein the data analysis server is configured to determine an event based on the capacitive data and the infrared data.

### TECHNICAL FIELD

The present disclosure generally relates to surface coverings. More particularly, it relates to a surface covering device for determining an event and a method thereof.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Existing floor surface covering or smart tiles, i.e. surface coverings with sensing devices and systems have grown to be more elaborate and complex. Such smart tiles have, however, presented challenges. For example, smart tiles with sensors positioned under a floor surface covering provide difficulties in installation and powering, generally inhibiting the efficient and effective, use of these smart tiles.

Existing surface coverings in the market include but not limited to tiles, for example, ceramic, marble, wood or even vinyl which enhances the design and aesthetic value of an industrial, commercial, outdoor or residential space. Moreover, once installed, it would be a challenge for users to replace the tiles or surface coverings due to the labour cost for removing and replacing it with new tiles once they are subjected to wear or tear, or when their design value has eroded over time.

With the industrial, commercial or residential spaces, it is often desirable to monitor the movement of users, or other inventory or objects within such spaces for tracking or security purposes. While security cameras and other movement sensors fulfil these purposes, it can intrude on personal privacy and cause unwanted attention.

Therefore, the present invention attempts to overcome at least in part some of the aforementioned disadvantages and to provide for an improved approach for addressing the foregoing challenge.

### SUMMARY OF THE INVENTION

According to a first aspect of the present disclosure, there is provided a surface covering device comprising a tile, a base assembly, a plurality of tile connectors located between the tile and the base assembly for releasably connecting the tile to the base assembly, at least one capacitive sensor located on the tile, wherein the capacitive sensor is configured to detect changes in capacitive data indicative of the presence of activity within a predetermined range of the capacitive sensor; an infrared sensor configured to receive infrared data; a capacitive controller communicatively coupled to an infrared controller configured for receiving the capacitive data and the infrared data from the capacitive sensor and infrared sensor respectively; a mesh controller configured to receive the capacitive data and the infrared data from the capacitive controller and infrared controller respectively, and a wireless transceiver in data communication with the capacitive controller and the infrared controller, wherein the wireless transceiver is configured to transmit the capacitive data and the infrared data to a data analysis server, wherein the data analysis server is configured to determine an event based on the capacitive data and the infrared data.

According to one embodiment, at least one capacitive sensor includes a plurality of capacitive pads that extends outwardly from the capacitive sensor to cover a section of the tile.

According to one embodiment, each capacitive pad detects changes in capacitive values indicative of presence of activity within range of the capacitive pad.

According to one embodiment, the event is associated with one or more predetermined range of capacitive values wherein each one of the one or more predetermined range of capacitive values is indicative of a predetermined pattern of activity.

According to one embodiment, the event is defined by capacitive values falling within a first predetermined range of capacitive values that is associated with footfall activity.

According to one embodiment, when the capacitive values fall within the first predetermined range of capacitive values associated with footfall activity, the infrared sensor transmits one or more control signals configured to be received by one or more electronic appliances, wherein the one or more control signals are configured for controlling an activation state of the electronic appliances.

According to one embodiment, the infrared sensor includes an appliance controller capable of storing the one or more control signals.

According to one embodiment, wherein the event is defined by capacitive values falling within a second predetermined range of capacitive values that is associated with presence of a fluid on the tile.

According to one embodiment, wherein the event is defined by capacitive values falling within a third predetermined range of capacitive values that is associated with a fall of a human on the tile.

According to one embodiment, when the capacitive values fall within the second or third predetermined range of capacitive values, the data analysis server is configured for communicating via a network with a user device to output an alert of the event associated with the activity associated with the second or third predetermined range of capacitive values.

According to one embodiment, the infrared sensor is configured for receiving a control signal from a user device, wherein the control signal controls the activation state of an electronic appliance.

According to one embodiment, the infrared sensor is configured for detecting changes in temperature of the surroundings, wherein a temperature detected above a threshold temperature is indicative of a fire.

According to one embodiment, the surface covering includes a controller board for mounting the mesh controller, capacitive controller and infrared controller.

According to one embodiment, the capacitive values received by the capacitive controller is indicative of a position of the surface covering device relative to adjacent surface covering devices within a premise.

According to one embodiment, the surface covering device includes an RFID reader configured to be activated to receive RFID signals from an RFID sensor attached to a human or object when the capacitive values fall within the first predetermined range of capacitive values associated with footfall activity.

According to one embodiment, the RFID signals include a tag identifier associated with the human or object.

According to one embodiment, the surface covering device includes a display interface in data communication with capacitive controller, the infrared controller and the mesh controller, wherein the display interface includes visual indicators visible through the tile.

According to one embodiment, the visual indicators include one or more of the following: a controller status indicator, network connectivity status indicator, mesh connectivity status indicator and calibration status indicator.

According to one embodiment, the base assembly further comprises one or more power connectors located at two edges of the base assembly.

According to a second aspect of the present disclosure, there is provided a method for determining an occurrence of an event, the method performed by an access management application on a user device in communication with a surface covering device, comprising the steps of: receiving capacitive data associated with an event occurring in a premise from a wireless transceiver on the surface covering device, wherein the capacitive data includes changes in capacitive values indicative of presence of activity; receiving infrared data associated with an event occurring in a premise from the wireless transmitter on the surface covering device, and determining, by a data analysis server, the event based on the capacitive data or the infrared data.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 illustrates a block diagram of a surface covering system in accordance with embodiments of the present invention;

FIG. 2 illustrates a perspective view of a surface covering device in accordance with embodiments of the present invention;

FIG. 3a is a perspective view of a tile in accordance with embodiments of the present invention;

FIG. 3b is a perspective view of a controller board in accordance with embodiments of the present invention;

FIG. 3c is a perspective view of a base assembly in accordance with embodiments of the present invention;

FIG. 4a is a perspective view of a base assembly with engagement interface in accordance with embodiments of the present invention;

FIG. 4b is a perspective view of a section of the edge of the base assembly in accordance with embodiments of the present invention;

FIG. 4c is yet another perspective view of a base assembly with engagement interface in accordance with embodiments of the present invention;

FIG. 4d is yet another perspective view of another section of an edge of the base assembly with an engagement interface in accordance with embodiments of the present invention;

FIG. 5a provides a perspective view of a base assembly and a removable tile of a surface covering device in accordance with the embodiments of the present invention;

FIG. 5b illustrates a block diagram of an access management application in accordance with the embodiments of the present invention;

FIG. 6a illustrates a close-up side view of two adjacent tiles in accordance with the embodiments of the present invention;

FIG. 6b illustrates a side view of two adjacent tiles in accordance with the embodiments of the present invention;

FIG. 7a illustrates a plan view of a tile with a display interface in accordance with the embodiments of the present invention;

FIG. 7b illustrates a close-up view of the display interface in accordance with the embodiments of the present invention;

FIG. 8 illustrates a block diagram of an access management application in accordance with the embodiments of the present invention;

FIG. 9 illustrates a block diagram of multiple surface covering devices connected to a user device and data analysis server in accordance with the embodiments of the present invention;

FIG. 10 illustrates a block diagram of multiple surface covering devices for controlling an electronic appliance in accordance with the embodiments of the present invention; and

FIG. 11 illustrates a flow chart of a method for detecting an event in accordance with the embodiments of the present invention.

### DETAILED DESCRIPTION

Reference will now be made in detail to an exemplary embodiment of the present invention, examples of which are illustrated in the accompanying drawings. While the invention will be described in conjunction with the embodiment, it will be understood that they are not intended to limit the invention to these embodiments. On the contrary, the invention is intended to cover alternatives, modifications, and equivalents, which may be included within the spirit and scope of the invention as defined by the appended description. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described. One skilled in the art will appreciate further features and advantages of the invention based on the above-described embodiments.

To achieve the stated features, advantages and objects, the present invention is directed to a surface covering device for providing information about an event, detecting or determining an event and/or to control external devices once an event has been detected. The present invention provides an intelligent tile for detecting, capturing and monitoring changes on or in the tile, or on the floor or portions of the floor. The present invention also provides a surface covering device that is easily installable and replaceable. This addresses some of the problems inherent in existing surface covering devices or smart tiles.

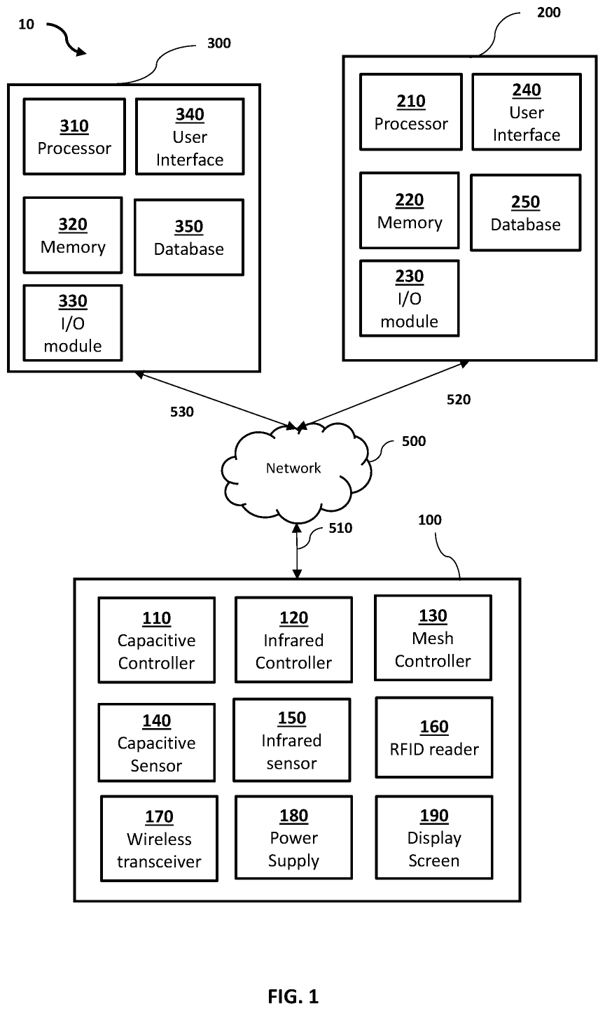

FIG. 1 provides a high-level block diagram of a surface covering system 10 in accordance with the embodiments of the present invention. The surface covering system 10 includes a surface covering device 100, a data analysis server 200 and a user device 300. The surface covering device 100 is connected to the data analysis server 200 and the user device 300 via the communications network 500 (for example, the internet) through respective communication links 510, 520, 530 implementing, for example, internet communications protocols. The user device 300 may be able to communicate through other communication networks, such as public switched telephone networks (PSTN networks), including mobile cellular communication networks. It should be appreciated that there may be one or more other communication devices similar to user device 300.

The surface covering device 100 includes one or more sensors 140, 150 positioned within the surface covering device 100 that provides information and data through a wireless communications medium or a wired medium to one or more controllers 110, 120, 130. The one or more controllers 110, 120, 130 collect data from the sensors 140, 150 and provide information to users based on the collected data. Details of the sensors 140, 150 and controllers 110, 120, 130 will be provided in more details later. The data from the sensors 140, 150 can be combined with data from other sources, including but not limited to, data from wall sensors, ceiling sensors, appliance sensors within electrical appliances or devices, product sensors, light sensors, other sensors within and external to the interior of the facility or room.

Sensors can transmit, send, or otherwise provide information to one or more data collecting components using various techniques that are known in the art. The provided information can include information collected by the sensors, information about the sensor's location, or any other appropriate information. In various embodiments, sensors include a capacitive sensor 140 and an infrared sensor 150.

The combination of one or more of the sensors maybe incorporated in a single tile or an array of tiles. For example, capacitive sensors 140 or infrared sensors 150 can be combined in a tile. Data from the sensors can be used for multiple applications. For example, an array of tiles with capacitance sensors 140 and infrared sensors 150 located in a residential or office space can be used to monitor the entry, presence and exit of occupants. That data can be used, among other things but not limited to: (i) control room lighting, (ii) control the turning on or off or aircon cooling systems or fans, (iii) other electrical appliances for example television.

The controllers 110, 120, 130 are configured and operable with the sensors 140, 150 to receive sensor data for storage into a memory (not shown) and to transmit the collected sensor data to a data analysis server 200 and a user device 300 via a wireless transceiver 170through a communications network 500. The data analysis server 200 is operable to analyze the collected sensor data and to present the data to the user device 300.

The data analysis server 200 may be a single server or have the functionality performed by the server distributed across multiple server components. The data analysis server 200 may include a number of individual components including, but not limited to, one or more processors 210, a memory 220 (e.g., a volatile memory such as a RAM (random access memory)) for the loading of executable instructions, the executable instructions defining the functionality the data analysis system 200 carries out under control of the processor 210. The processor can include any suitable processor, such as an Intel® Pentium processor, Intel® Core 2 Duo processor, AMD Opteron™ processor, or UltraSPARC processor. The data analysis server 200 may also include an input/output (I/O) module 230 (which may be or include a transmitter module and/or a receiver module) allowing the data analysis server 200 to communicate over the communications network 500. A User interface (UI) 240 is provided for user control and may include, for example, one or more computing peripheral devices such as display monitors, computer keyboards and the like. The data analysis server 200 may also include a database (DB) 250, the purpose of which will become readily apparent from the following discussion.

The user device 300 is in communication with the data analysis server 200 and the surface covering device 100 via a communication network 500. The user device 300 may include a number of individual components including, but not limited to, one or more processors 310, a memory 320 (e.g., a volatile memory such as a RAM) for the loading of executable instructions, the executable instructions defining the functionality the remote device 300 carries out under control of the processor 310. The user device 300 also includes an input/output (I/O) module (which may be or include a transmitter module and/or a receiver module) 330 allowing the remote device 300 to communicate over the communications network 500. A user interface (UI) 340 is provided for user control. In some embodiments, if the user device 300 is, say, a smart phone or tablet device, the user interface 340 may have a touch panel display as is prevalent in many smart phone and other handheld devices. Alternatively, in other embodiments, if the user device 300 is, say, a desktop or laptop computer, the user interface 340 may have, for example, one or more computing peripheral devices such as display monitors, computer keyboards and the like. The user device 300 may also include satnav components (not shown), which allow the user device 300 to conduct a measurement or at least approximate the geolocation of the user device 300 by receiving, for example, timing signals from global navigation satellite system (GNSS) satellites through GNSS network using communications channels, as is known.

As used herein, the user device 300 may exchange information via any communication network, such as a Local Area Network (LAN), a Metropolitan Area Network (MAN), a Wide Area Network (WAN), a proprietary network, and/or Internet Protocol (IP) network such as the Internet, an Intranet or an extranet. Each device, module or component within the system may be connected over a network or may be directly connected. A person skilled in the art will recognize that the terms ‘network’, ‘computer network’ and ‘online’ may be used interchangeably and do not imply a particular network embodiment. In general, any type of network may be used to implement the online or computer networked embodiment of the present disclosure. The network may be maintained by a server or a combination of servers or the network may be serverless. Additionally, any type of protocol (for example, HTTP, FTP, ICMP, UDP, WAP, SIP, H.323, NDMP, TCP/IP) may be used to communicate across the network. The devices and systems as described herein may communicate via one or more such communication networks.

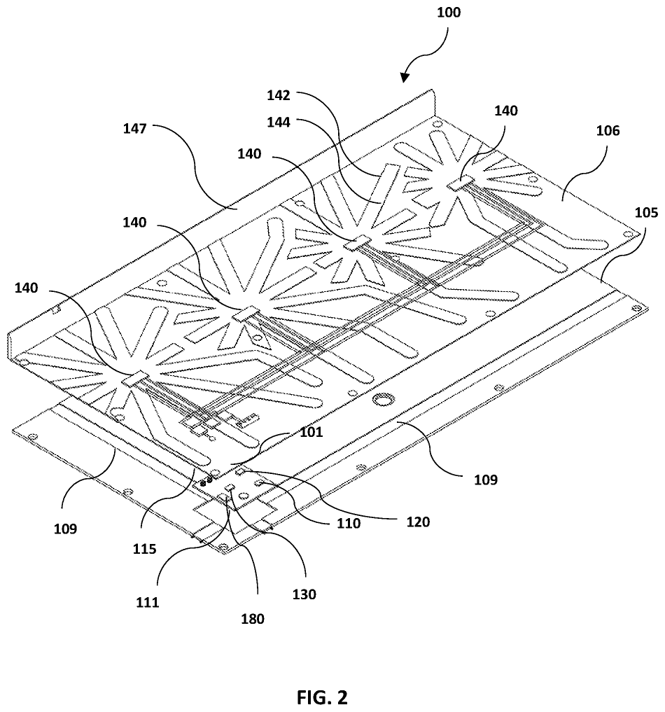

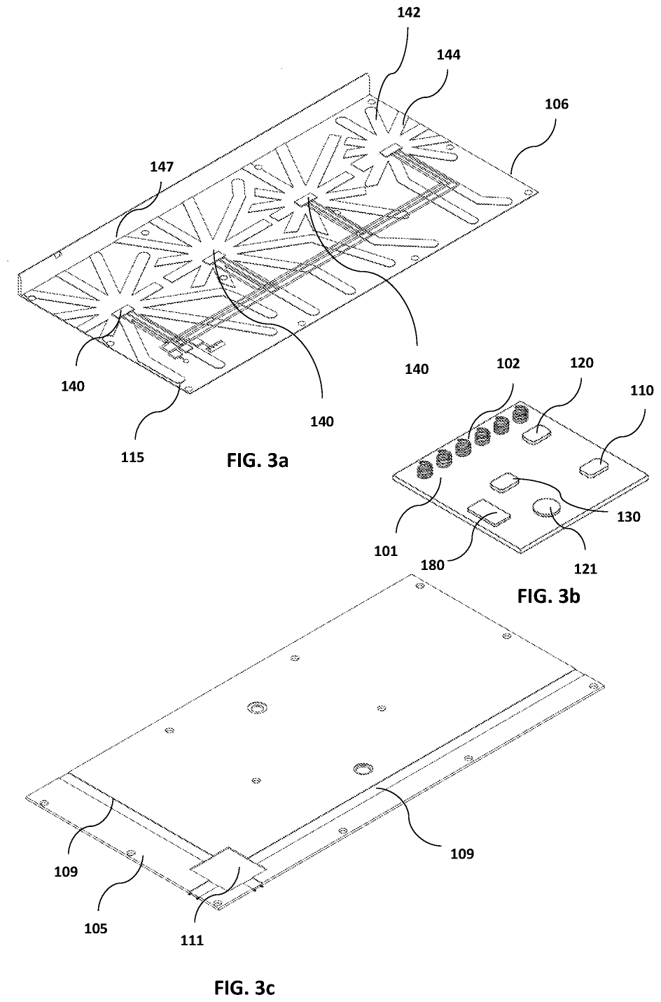

FIG. 2 is a perspective view of a surface covering device 100 in accordance with embodiments of the present invention. The surface covering device 100 includes a base assembly 105 and a tile 106 that is removably attached to the base assembly 105. FIG. 3c shows a perspective view of the base assembly. The base assembly 105 includes a receptacle 111 for receiving one or more controllers 110, 120, 130. FIG. 3b shows a perspective view of a controller board for the controllers. The one or more controllers are preferably mounted on a controller board 101. In an embodiment, the controller board 101 is a printed circuit board (PCB) configured for mounting on the receptacle 110. The base assembly 105 is made of an epoxy material or HDPE (High Density Polyethylene) or any plastic, wood, metal material that is capable of supporting the removable tile. The controller board 101 includes a power supply 180. The base assembly includes channels 109 for receiving a power cable that is in communication with the power supply 180 and controllers respectively. The advantage provided by the aforesaid surface covering device 100 is that all the components, i.e. the base assembly 105, the controller board 101 holding the one or more controllers, and the tile 106 of the surface covering device 100 are replaceable. The controllers 110, 120, 130 are modular and interchangeable as and when desired by the user and a user can easily replace a controller when desired for various functions.

The ability to replace the removable tile 106 comes in handy when it comes to maintenance and repairs as the entire surface covering device 100 need not be replaced. In some embodiments, the replaceability of the tile 106 is an advantage for users who wish to change the color of the tile 106 a few years down the road without incurring a huge cost. This is not possible for office or residential dwellers who opt for ceramic tiles installed with cement as now the whole ceramic tile must be broken, and the installation of a new ceramic tile will once again acquire material and labor cost. Hence, office or residential owners will find it difficult to change their tiles once it has been installed primarily due to the cost. The present invention provides an easy and cost-effective way of replacing the removable tile 106, and opens a whole new world of opportunities where home owners may actually want to try out different colored tiles over the years.

FIG. 3a shows a perspective view of the removable tile 106. The tile 106 includes one or more capacitive sensors 140 located on the upper surface of the tile. The capacitive sensors 140 provide data through a wired or wireless communication medium to the one or more controllers 110. In some embodiments, the capacitive sensors 140 detect changes in capacitive data, and send the capacitive data to the capacitive controller 110. The capacitive data include capacitive values. The capacitive sensors 140 are positioned at regular intervals throughout the tile 106 to maximize the coverage for detection by the capacitive sensors 140. Each capacitive sensor 140 includes a plurality of capacitive pads 142, 144 in data communication with the capacitive sensor 140. Each capacitive pad is capable of tracking or detecting presence of an object or a human within 5-10 cm of the tile 106. Each capacitive sensor 140 is capable of detecting the capacitive value of each capacitive pad it is connected to. In some embodiments, each capacitive sensor 140 includes twelve capacitive pads 142, 144 to maximize coverage of a section of the tile 106, thereby minimizing the use of capacitive sensors. In some embodiments, the capacitive sensor 140 includes a plurality of capacitive pads extending outwardly from the capacitive sensor 140 to cover a section of the tile. In some embodiments, the capacitive sensor 140 has a plurality of capacitive pads in a fan-shaped pattern that covers a section of the tile. Although a selected number of capacitive pads connected to each capacitive sensor is shown, any number of capacitive pads can be selected based on the shape and size of the tile 106. The capacitive sensors 140 are in data communication with one another and are connected to the capacitive controller 110 via wired or wireless communication, details of which will be explained later. Although a selected number of capacitive sensors are shown, any number of capacitive sensors can be used depending on the shape and size of the tile. The capacitive sensors 140 are configured such that they are unnoticeable on the top surface of the surface covering device 100. In some embodiments, a thermosetting polymer, for example, epoxy is poured on top of the capacitive sensors 140 and other components on the top surface of the tile with a high concentration of colourant so as to conceal the capacitive sensors and its components.

In order for the capacitive pads to detect a change, the object is located at a maximum height above the tile. The maximum height can be 10 cm. However, the maximum height can change depending on the improvements in capacitive sensor technology. The object is generally conductive or have a moderate surface area. This means that small pieces of paper and or cardboard cannot be detected. Therefore, only relevant features such as water detection, fall detection, foot steps by humans or conductive objects can be detected. In some embodiments, each capacitive pad is made of copper tape that is usually about 5 to 10 cm in width thereby providing a large sufficient area. The advantage of using copper tape is the shape of the pads can be configured easily by using simple tools such as a pen knife. Each copper pad has a horizontal detection range of about 30 cm in radius. In general the copper pads can be any metal that has high electrical conductivity. The higher the electrical conductivity, the better the performance of the capacitive system as a whole.

The capacitive value obtained by each capacitive pad is measured in terms of counts. In normal operation where nothing is in the vicinity of the tile, the capacitive value is around 100 counts. If water is poured, the count drops to 95. If a step is detected, the capacitive value drops to 80 counts. If someone falls, due to the large surface of the torso, the capacitive pads near the torso can report capacitive values as low as 50 counts and those in the leg area report capacitive values around 70 counts. Hence, a specific range of counts can be determined to differentiate between a fall and a foot step. For footsteps, we would see the value of 2 adjacent capacitive pads drop to 80 which for a fall we would see changes across the whole tile and the torso region would have a much greater change than the leg area.

In some embodiments, the capacitive sensors 140 are in data and electrical communication with one another. In some embodiments, the capacitive sensors are connected via the I2S protocol I2C protocol. The I2C protocol uses a master-slave architecture, where one device acts as the master and initiates communication with one or more slave devices. The master device controls the communication by sending commands and data to the slave devices, which respond with data as required. The I2C protocol uses a two-wire serial bus consisting of a data line (SDA) and a clock line (SCL). The data line is bidirectional and carries the actual data being transmitted, while the clock line provides the synchronization signal for the data transfer. This allows us to connect up to 70 sensors to 1 microcontroller using just four wires which are VCC (Power), GND (Ground), SCL and SDA In some embodiments, the electrical connection from each capacitive sensor 140 is in communication with a metal contact 115 located on the underside of the tile 106. The metal contact 115 may or may not be collocated together with the other metal contacts from the other capacitive sensors 140. In some embodiments, a metal contact 115 corresponding to each capacitive sensor 140 is positioned on the underside of the tile 106. The controller board 101 includes one or more springs 102 corresponding and aligned with each metal contact 115 from the tile 106 to provide data and electrical connection.

In some embodiments, each tile 106 may include a skirting 147 that is pre-installed in each tile that is going to be installed on a wall surface. The skirting 147 extends upwards from one side of the tile 106 and is installed on the wall surface that it is in contact with. This once again reduces the need of concrete and manpower thereby making our tile more cost effective. There is also a slot in the skirting for wires to run through to the bottom tile.

FIG. 3b is perspective view of a controller board including its components. The controller board 101 includes a plurality of controllers. The controller board 101 includes a plurality of springs 102 attached to the surface of the controller board 101. The springs are aligned with the metal contacts 115 of the tile 106. The controllers 110, 120, 130 are responsible for capacitive related-activities, Infrared-related activities and mesh-related activities. For instance, the capacitive controller 110 receives capacitive data from the capacitive sensors for storage into a memory (not shown) and to transmit the capacitive data to a data analysis server 200 and a user device 300 via a wireless transceiver 170 through a communications network 500. For example, the infrared controller 120 receives infrared data from the infrared sensor 120 and the mesh controller 130 receives the capacitive data and the infrared data from the respective controllers. In some embodiments, the three controllers are in data communication with one another and is able to send data among themselves. For example, the capacitive controller 110 can send capacitive data and infrared data to the infrared controller 120 or the mesh controller 130. The infrared receiver 121 is in data communication with the infrared controller 120, and is configured for controlling and operating electrical appliance or other external devices by emitting infrared light that includes data encoded with a suitable carrier frequency. The encoded data is received by a receiver stored in the electronic appliance or other external devices for operating the electronic appliance or external device. The springs 102 on the motherboard acts as the electrical medium that connects the controllers on the base assembly 105 to the sensors in the tile 106. The use of springs hinders the use of long wires which requires additional slot to be cut which only weakens the tile structurally. On the other hand, the use of short wires will make it extremely hard for the installer to make an connection. Hence, the use of springs avoids such issues completely and allows for the efficient transfer of power and data lines transmission.

The mesh controller 130 allows capacitive data and infrared data to be routed to and from the various controllers via mesh networking. Mesh networking is a type of local network topology that allows nodes to connect directly and dynamically with each other without a central node. This enables efficient data routing to and from clients as nodes work cooperatively to relay each other's transmissions. Mesh networks can support auto-networking, where any node can scan and connect to access points easily. With a single router, up to 87 nodes can be connected.

The advantage of mesh networking is that nodes can communicate with each other to ensure that data packets reach their final destination without needing to be in range of a central node. Nodes can self-organize, which means that if a node is removed from the network, other nodes can take over its function to ensure that packets still reach their destination. In a typical mesh network, the coverage area can be much larger since nodes can achieve inter-connectivity without needing to be in range of the central node. In this case, the stations are the microcontrollers inside the tile.

As the tiles are already side by side, the mesh controller creates an extremely strong and reliable mesh network within the environment in which the tile is installed. In an embodiment, the mesh network can be encrypted for each user and hence each of them can have their own private mesh network free of charge.

### How the Mesh Network is Used

The Mesh network uses JSON (JavaScript Object Notation) for all its messaging. Via this JSON message, specific devices can be turned on and off as instructed by a user.

For instance, in the following message, the mesh controller can instruct a controller with an appliance identifier ID: FCCDE3498354 to turn on which in turn can operate a relay to turn on a group of electrical appliances with the appliance identifier, for example, a fan, light, water heater or an even air conditioner, in individual or in combination. The user can configure the appliance identifier to control one or more appliances.

```
{
  “Target_ID”: “ FCCDE3498354”,
  “ON”:TRUE,
  “Sender_ID”: “ FCCDE3497890”,
  “Group_ID”: “AlexHome”
}
```

In this following message, the mesh controller sends instructions to an another mesh controller embedded with the appliance identifier ID: FCCDE3498354 to turn off which in turn can operate an relay to turn off a group of electrical appliances with the appliance identifier, for example, a fan, light, water heater or even an air conditioner, in individual or in combination, as configured by the user.

```
{
  “Target_ID”: “ FCCDE3498354”,
  “ON”:FALSE,
  “Sender_ID”: “ FCCDE3497890”,
  “Group_ID”: “AlexHome”
}
```

By assigning all of the appliances in a home an appliance ID known as the target ID, we can control any number of devices easily via the mesh network. This helps to greatly remove the burden placed on the internet network. For instance, having too many IoT devices, can slow down the overall internet speed in the user's home. However, the mesh network does not utilise the user's internet network. Instead, it creates its own mesh network which relieves the pressure from the home's internet network.

The mesh network can also do more than just on and off actions. For instance, in the following message, the mesh network is able to change the colour of an led to red.

```
{
  “Target_ID”: “ FCCDE7899583”,
  “ON”:TRUE,
  “RED”:255,
  “GREEN”:0,
  “BLUIE”:0,
  “Sender_ID”: “ FCCDE6514487”,
  “Group_ID”: “AlexHome”
}
```

Hence, the mesh network can be used to send a set of complex instructions to any machine.

The controller board 101 includes a wireless transceiver 170 in data communication with the controllers and configured to transmit and receive data wirelessly via wireless communication protocols, for example, short-range or long-range wireless communication protocols. In some embodiments, the wireless transceiver 170is intended for transmitting and receiving data associated with the sensors 140, 150 and the data analysis server 200. Although shown as separate components in FIG. 1, the wireless transceiver 170 can be integrated with one or more controllers. In some embodiments, the functions may include configuration of a surface covering device that is operably connected to another surface covering device via a cable or wirelessly and may be varied to accommodate desired needs and situations. In some embodiments, the wireless transceiver 170 is configured to transmit data captured by the sensors to the data analysis server 200 via a network 500, details of which will be explained hereinafter.

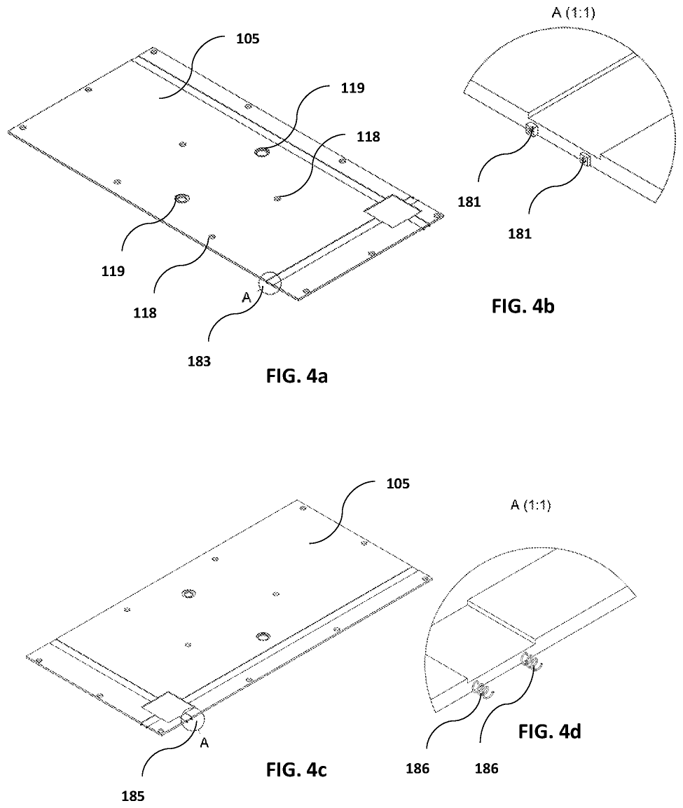

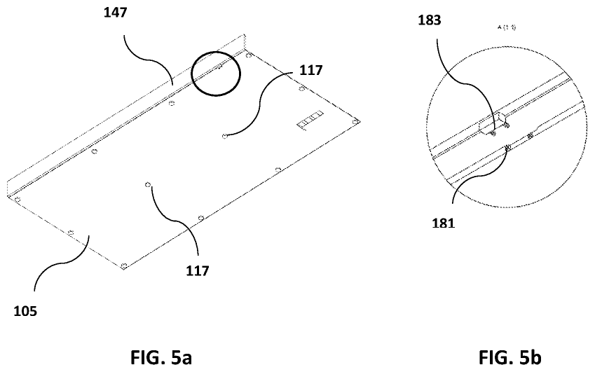

FIGS. 4a and 4c are perspective views of a base assembly. FIG. 4b is a perspective view of a section of an edge of a side of the base assembly and FIG. 4d is a perspective view of another section of an edge of another side of the base assembly. The base assembly 105 includes tile connectors for securing the tile 106 to the base assembly 105. A countersink aperture 119 is configured for securing the tile to either a wooden or concrete floor with the aid of suitable screws such as masonry screws or wood screws. The tile connectors include an aperture 118 configured to receive a corresponding insert 117 (shown in FIG. 5a) that are attached to the removable tile 106. A plurality of apertures 118 and corresponding inserts 117 are located on suitable locations on the base assembly 105 and the tile 106 respectively. As the inserts 117 are attached to the removable tile 106, the inserts 117 will ensure a tight fit with the aperture 118 on the base assembly and guarantee that the removable tile 106 and base assembly 105 act as one piece. In various embodiments, the inserts 117 include but are not limited to nylon inserts.

The base assembly 105 includes an engagement interface on the edge of a side of the base assembly. A power supply 180 provides power to the sensors through a power cable that is received by the channels 109 and operably connected to the controllers and a wireless transceiver. The power supply 180 may include a power converter module. The power supply 180 is also operably connected to power connectors 183 attached to at least two sides of the base assembly 105. The engagement interface includes power connectors 183 which are electrical contacts that are configured to contact with corresponding power connectors 186 on an adjacent base assembly. The power connectors 183 includes one or more electrical contacts. The power connectors 183 include at least one male connector 186 on one tile and at least one female connector 181 on an adjacent tile configured to receive the male connector 186. In some embodiments, each power connector 183 includes a female connector 181, for example, a thin metal plate with a dimple, that allows a corresponding electrical contact from an adjacent tile to align in place and pass electricity smoothly. In some embodiments, each side of the base assembly can include either a male connector 185 or a female connector 183, and each can be connectable to a corresponding connector on the proximate base assembly. The power connector 183 comprises a male power connector 185 and a female power connector 181, each of which is removably attached to each other for transmission of power between one base assembly to a neighboring base assembly. For example, the male power connector of a base assembly is connectable to the female power connector of a proximate base assembly. Each of the aforesaid components are operably connected to one another via cables received within channels 109. The corresponding male connector 185, for example, can be a spring 186 or any other suitable contact for engagement with the female connector 181. The use of electrical contacts as a female connector and springs as male connectors eliminates the use of wires and connectors. This is crucial as there is not much space between adjacent tiles to implement thick wires or connectors. Moreover, the use of springs, prevent installers from connecting the polarity wrongly and destroying the electric circuitry. For instance, if electrical connectors were to be used, the installer may accidently connect the positive end of the power supply to the negative end of the power supply resulting in the destruction of many electrical components. However, with the use of springs, the flow of electricity is already predetermined and hence there is no room for human error. This allows tiles to be placed side by side continuously while ensuring a good connection.

FIG. 5 is a perspective view of a base assembly 105 with skirting. FIG. 5b is a close up view of a power connector between the skirting and the base assembly. The skirting 147 is removably connected to the base assembly 105. A power connector 183 is located at a suitable point along the skirting 147 that aligns with a corresponding power connector 181 located on the longitudinal edge of the base assembly 105. The power connectors 181, 183 are in electrical communication with the power supply 180 within the base assembly 105 via a power cable that runs through the base assembly 105. This enables the power supply 180 to be powered by an external power supply, for example, the power mains of the facility.

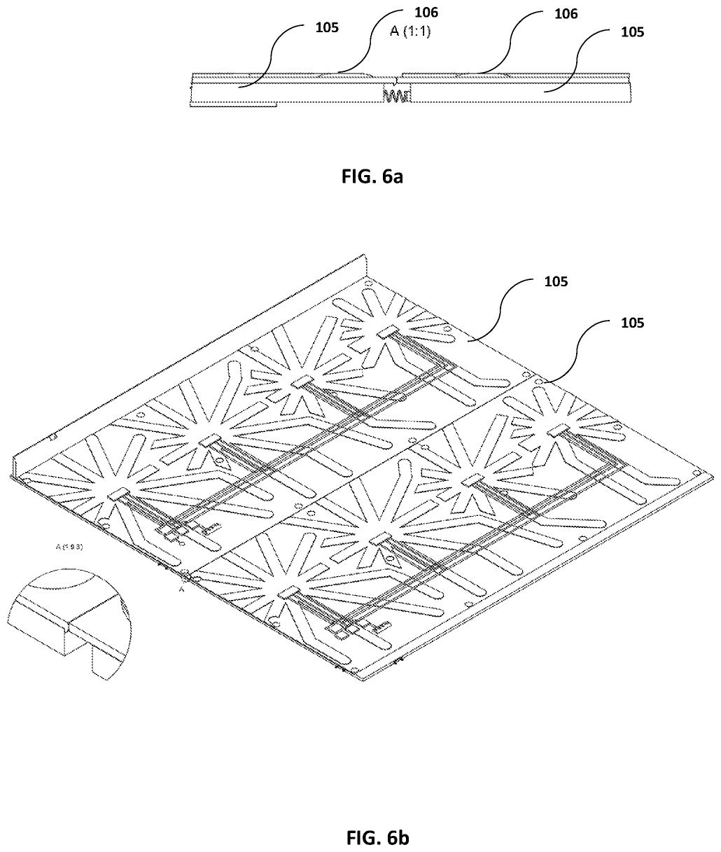

FIG. 6a is a side profile view of two adjacent tiles in connection with each other. FIG. 6b is a perspective view of the joining section between the adjacent tiles. As mentioned in FIGS. 4a-4d, the engagement interface located on one edge of the base assembly and the engagement interface located on one edge of an adjacent base assembly allows for data and electrical communication between adjacent base assemblies. The male connectors and corresponding female connectors of adjacent base assemblies (i.e. electrical contact and springs respectively) will contact each other resulting in the flow of electricity. Concurrently, a resilient material such as silicon, rubber or any other flexible material is attached on the left and top side of the removable tile 106 compresses against the other adjacent tile. This creates a waterproof seal eliminating the need for grout. At the same time, it blocks the viewer's access to seeing the gap that actually exists below. Eliminating grout makes the tile much more cost friendly by removing much of the labor cost associated with laying of grout and the cost of grout itself.

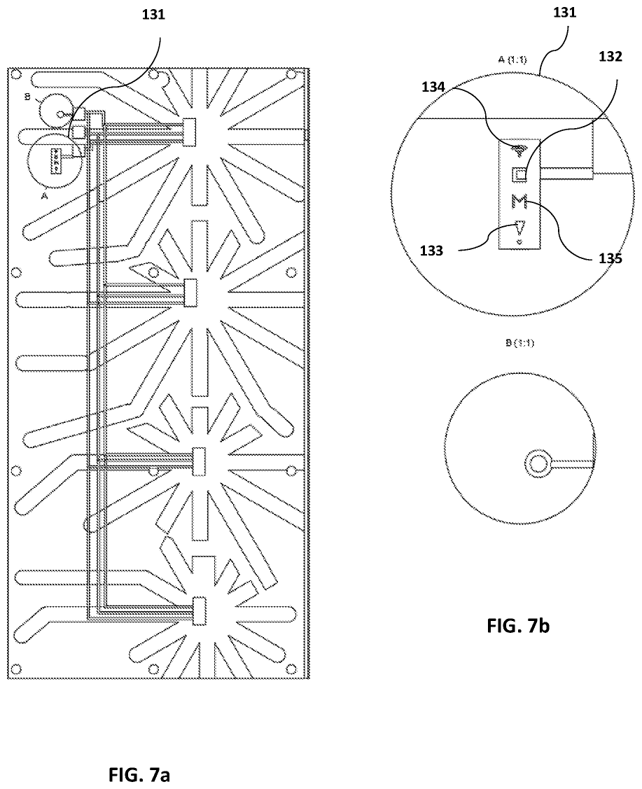

FIG. 7 is a plan view of the top side of the tile with a display interface including a plurality of visual indicators. The display interface 131 provide visual indicators that are visible through the removable tile 106 and provide useful information of the status of the surface covering device 100 to the user for making decisions pertaining to the condition of the surface covering device 100. The visual indicators include but are not limited to battery status indicator, controller status indicator 133, network connectivity status indicator 134, mesh connectivity status indicator 135, and calibration status indicator 132. In some embodiments, neo pixel lights are placed under diffusers that are cut to specific shapes to only allow light of a specific shape to bleed through the removable tile. The network connectivity status indicator 134 allows a user to know the status of the network connectivity, for example, WIFI connectivity. For example, if the network status indicator 134 is red, this indicates that the controllers are having issues with connecting to the network and hence, the network settings must be checked. If the network status indicator 134 turns green momentarily, then this indicates the controllers have successfully connected to the network. The calibration status indicator 132 lets the user know if a component within the surface covering device have been calibrated properly. The calibration status indicator 132 turns blue when the controllers are calibrating the capacitive pads of the capacitive sensor. The mesh connectivity status indicator 135 (i.e. the M shaped icon which stands for “Mesh”). This icon turns red when there is a fault with the mesh controller. The icon turns blue when the mesh controller is engaging in mesh related activities. The controller status indicator 132 (i.e. the ‘exclamation mark’ indicator) is used to indicate the condition of the controllers. In its default state, the controller status indicator is not activated. However, when one or more of the controller is inoperable or crashes (being stuck in the same line of code for long periods of time), the exclamation sign turns red in color that indicates to the user that there is an issue related to the controllers or the software related to the controllers. It also lets the users know that the tile is not in an operable mode.

The surface covering device 100 include a removable tile 106 that includes a ceramic tile, porcelain or slate tile, vinyl tiles, linoleum, hardwood flooring, engineered wood flooring, laminate flooring, epoxy tile, artificial grass or turf, bricks or pavers, stones, and composite tile or decking carpet such as a commercial style or a pile carpeting style. Although many of the example surface covering devices provided or detailed herein pertain primarily to indoor flooring, it should be understood that the various embodiments as described herein may alternatively be implemented outdoors or on wall surfaces.

Data collected from the aforesaid sensors may be used to detect many types of events and objects. In some embodiments, capacitive sensor 140 may detect and associate a series of footfall impacts that indicate that a person is walking, where the person is walking, and how fast the person is walking. Capacitive data collected from the capacitive sensor 140 may also be used to detect that a person has fallen to the floor. The capacitive data include capacitive values from each capacitive pad associated with the capacitive sensor that is indicative of various events. For instance, within various ranges of detected capacitive values (measured in counts), the detected event can indicate an unauthorized person is walking in a restricted area, that water has flooded a particular portion of a basement, or that a person has exited from a window. The information may additionally or alternatively be collected and used over time. Capacitive data collected over time may be used to identify patterns and deviations from patterns. As examples, the capacitive data may be used to detect a person's behavioral patterns, provide warnings based on deviations from expected behavioral patterns, estimate facility usage rates (e.g., an average of thirty persons walk down a hallway per day), estimate expected floor replacement needs based on usage rates, among many other possible uses.

The surface covering device 100 obtains electrical power from a power supply 120. In some embodiments, the power supply 120 can be a battery energy source, for example, a rechargeable battery such as a rechargeable lithium ion battery. In some embodiments, the power supply may provide 24 volts of direct current to the surface covering device 100. In some embodiments, the power supply 120 includes a power converter module to convert 240V AC or 24V DC to a smaller voltage requirement, for example, 5V DC. As shown in FIGS. 5a and 5b, the power supply can be configured through the use of power connectors in the skirting to obtain power from an electrical mains within the facility and provide conditioned for use. To provide real-time continuous monitoring of the enclosed space at all times, an independent power supply is provided for each surface covering device that powers the sensors, controller and other components.

### Access Management Application

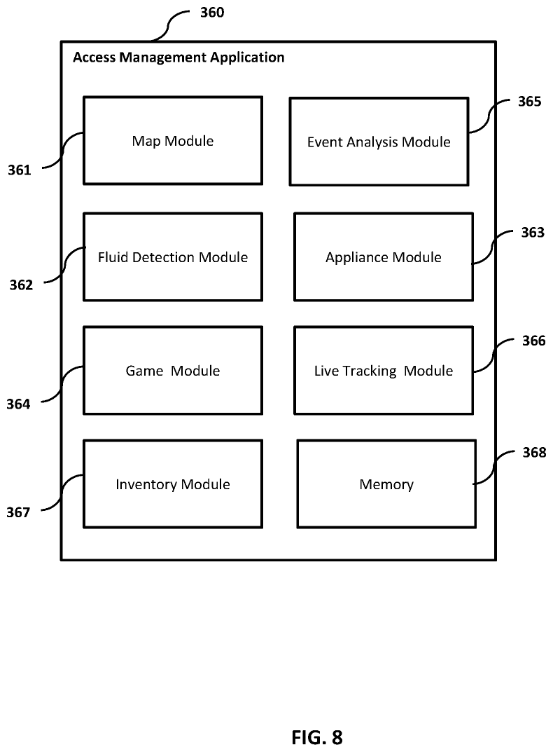

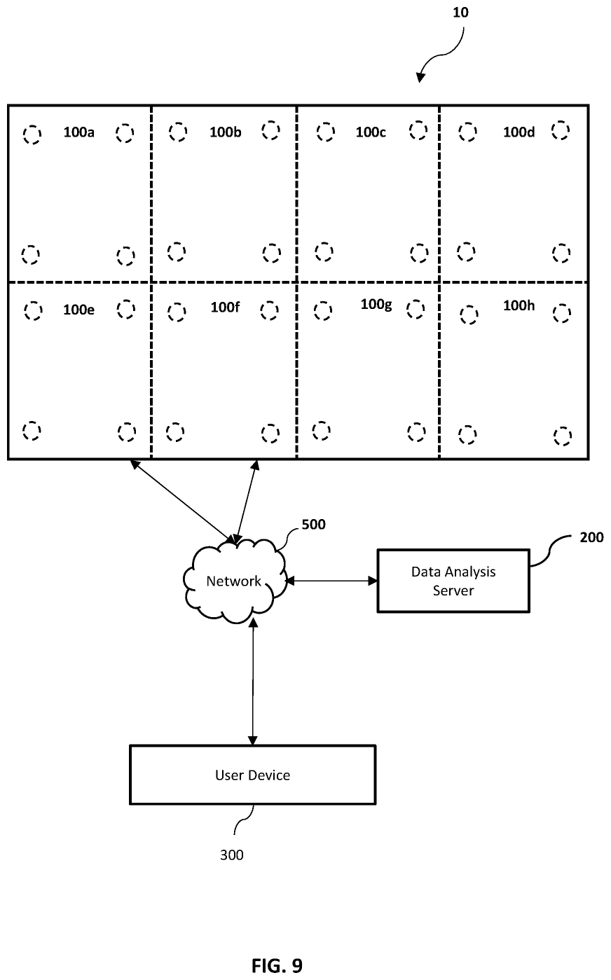

FIG. 8 illustrates a block diagram of an access management application in accordance with the embodiments of the present invention. A user can download and execute an access management application 360 on the user device 300 for operating an array of surface covering devices (100a-100h shown in FIG. 9) that are physically connected to one another on a floor or wall surface in any suitable or desired configuration. In various embodiments, the user device 300 runs an operating system that allows the access management application 360 to be written in compliance with the operating system to be executed on the user device 300. The user device 300 is further capable of engaging in data communication sessions using the GPRS protocol that in turn allows the user device 300 to connect to a data analysis server 200. This connection is facilitated by the operator of a mobile network. The user of the user device 300 wishes to operate the array of surface covering devices by downloading as an access management application that is not currently available on his user device or accessible via a network browsing application on the internet. The access management application 360 is configurable by the user for monitoring the surface covering devices. Having downloaded the access management application associated with the operation of the surface covering system, the user can activate the access management application on his user device.

The access management application 360 includes but is not limited to, a plurality of modules such as a map module 361, a fluid detection module 362, an appliance module 363, a game module 364, an event analysis module 365, a live tracking module, an inventory module 367, and a memory 368 for storing data. Each of the modules of the access management application will be explained in detail hereinafter. The access management application 360 may be used by residential, retail, building management, or healthcare facility operators such as department stores, supermarkets, commercial buildings, office operators, nursing homes or healthcare facilities. The access management application 360 may include a dashboard module.

FIG. 9 is a high-level block diagram illustrating a surface covering system 10 in operation for an enclosed environment. The array of surface covering devices 100a-100h can be positioned throughout a floor surface based on use and purpose, covering the floor layout partially or entirely. For example, the surface covering devices can be positioned in greater concentrations in certain parts of a room, retail space, office or facility to achieve a particular objective. For example, surface covering devices may be more concentrated on a secured area to facilitate greater security in that area than other areas of a room, retail space, office or facility. In some embodiments, the surface covering devices may be more concentrated in the relatively higher risk locations of an elderly living facility for monitoring accidents or falls in the location. The surface covering devices 100a-100h are installed first in the enclosed environment and assigned locations based on the actual location of the sensors embedded within each surface covering device. For example, each surface covering device is assigned a number, for example, tile 1, tile 2, tile 3 etc. While the surface covering devices are connected physically to one another to form a particular layout or configuration, they operate independently of one another, each with its own power supply, and the data collected by the sensors on each surface covering device are transmitted individually to the data analysis server via the network 500. The position of each tile in a layout of a room is mapped digitally and the location of each tile is determined based on the tile number relative to the digital map layout.

In other embodiments, each of the surface covering device is initially assigned prior to installation on the floor surface and laid out in a particular order, for example, sequential order, either by rows or columns. The result of such an assignment process may provide sensors that individually store accurate identity codes (for example, tile 1, tile 2, tile 3 etc.) and a mapping of the locations of the group of sensors relative to a layout of the room. In other embodiments, the user can configure the sensors located in each surface covering device manually on a floor layout by assigning a location code to each surface covering device corresponding to a logical location of the tiles on the floor layout.

The layout of the room may be previously known, detected by a separate process, or detected as part of the same process that assigns the sensor identity and location information. A graphic showing a floor layout and sensor locations may be produced, stored, and used in later processes on the data analysis server 200. The graphic of a room or floor layout with the tile and sensor locations may be used as part of the output of a means for detecting an event and activating user configured protocols based on the detected event. For example, a user can quickly understand which tiles and sensors have provided the relevant information, e.g., to see where an elderly resident has fallen within the resident's room.

In some embodiments, the event analysis module 365 receives the data obtained from the sensors, for example, capacitive data from the capacitive sensors, from the data analysis server, and provides a heat map of the capacitive data in the form of capacitive values received from each capacitive pad associated with the capacitive sensor by each of the surface covering devices that is associated with the frequency and impact of a foot with the surface covering devices within the floor layout. The event analysis module processes the capacitive data and applies a first set of rules configured for identifying an event associated with the capacitive values associated with the capacitive data. In some embodiments, the event can be a predetermined pattern of activity or movement based on a range of capacitive values. For instance, a range of very low capacitance values resembles a human shape can indicate whether someone is lying on the floor or someone who has fallen.

The table below shows the events for identification based on the respective capacitive data received from the controller, details of each event to be explained hereinafter. The data analysis server 300 will receive the capacitive data or infrared data to identify and determine the event so that a predetermined action by the data analysis server will follow. For example, if the controller in the base assembly receives and transmits only capacitive data to the data analysis server, the data analysis server will identify one of the following events: footfall activity, live tracking, a fall, fluid detection or a game. In some implementations, the user configures the base assembly for a specific event or events such that only specific events can be detected based on at least one of the data received by the data analysis. In some embodiments, if the user decides that the specific events to be detected, this can be configured on the access management application. The user can configure the event analysis module to detect only certain events, for example, live tracking of humans for security applications and fire detection, and the data analysis server will only determine such events based on the received capacitive data and infrared data from the base assembly.

TABLE 1

| | | Capacitive | | |
|---|---|---|---|---|
| | Change in | Value | | Infrared |
| | Capacitive | Range | Infrared | Data |
| Event | Data | (Counts) | Data | Range |
| Footfall | Present | 80-90 | Not | Not |
| activity/traffic | | | required | required |
| Fluid Detection | Present | 95 | Not | Not |
| | | | Required | Required |
| Live tracking of | Present | 80-90 | Not | Not |
| humans (without | | | required | required |
| RFID tag) for security | | | | |
| applications | | | | |
| Fall/Heavy Impact | Present | <50 | Not | Not |
| | | | required | required |
| Fire Detection | Not | Not | Present | 2 m |
| | required | required | | |
| Electronic Appliance | Not | Not | Present | 2 m |
| Control | required | required | | |
| Game | Present | 70-100 | Not | Not |
| | | | required | required |

### Detection of a Fall/Heavy Impact

In some embodiments, a fall detection or heavy impact on one or more surface covering devices can be based on the capacitive data received by the data analysis server from the sensor controller 110 which can be indicative of a potential emergency situation. From the capacitive data received from the capacitive sensor, the data analysis server can identify if the capacitive data received is indicative of a normal footfall or a heavy impact or impact of other types. For example, in some embodiments, a normal capacitive value of a tile is 100 in a default mode. When a person walks over a tile, the capacitive value has a value of 80-90 which can be detected on 2-3 capacitive pads. The normal capacitance value is 100. When a person falls on the tiles, the whole body is now closer to the tile hence, the value drops to 50 for about 10 capacitive pads over one or more tiles that will closely resemble a human shape. The data analysis server would identify the capacitive data to be indicative of a fall or heavy impact and send an alert to the user that a possible fall may have been detected. In some embodiments, the data analysis server can assess the map module on the access management application and determine if a potential emergency situation has occurred. For example, if an elderly spends approximately an average of 5 to 15 min in the bathroom, and if the capacitive data is assessed by the data analysis server that the elderly has been in the bathroom for more than 30 mins and the capacitive data has not changed, this would then imply that the elderly maybe facing some difficulties or in the worst case, may have slipped and fell.

### Live Tracking for Security Applications

In some embodiments, the access management application includes a live tracking module which displays footfall in real time. The embodiment described provide capabilities to facilities or structures where it may be impractical or unfeasible to provide infrastructure for camera or other sensing systems. This could be due to personal privacy issues. The array of surface covering devices on the floor of the facility may be configured for security applications to detect if a person or animal has entered a facility thought to be unoccupied or highly secured area. For example, the surface covering devices may detect changes in capacitive data caused by a detection of pressure on the surface covering devices when a person or animal is walking on the surface covering devices. The capacitive data is transmitted to the data analysis server, wherein a capacitive value within a range of predetermined capacitive values will trigger an activation of an email or message alert on the access management application of the user device, and pinpoint the location of the intruder within the facility.

In other embodiments, capacitive data received can be indicative of footsteps detected within an area of interest when there is not supposed to be any footsteps. For example, if a child is sleeping in a home and footsteps are detected in the living room, this can indicate that an intruder may have entered the house which can potentially endanger the inhabitants of the home. The users can be alerted of the possible intrusion.

In other embodiments, the footfall activity includes a navigation pattern of one or more persons. For example, a movement of the footfall activity associated with a similar capacitive data on one or more surface covering devices over a predetermined time period within the floor layout is indicative of the directional movement of one or more persons within the enclosed environment. In some embodiments, the heat map is represented by green, varying shades or orange and red, with each color representing the frequency and impact of footfall activity on the surface covering device. For example, a green can be associated with light footfall activity (i.e. that falls within a first predetermined range of capacitive values), and a red can be associated with a heavy footfall activity (i.e. that falls within a second predetermined range of capacitive values). Each color can be configured by the user to determine the frequency and impact of the footfall activity. In some implementations, capacitive data received by the capacitive sensor is used for determining footfall activity. For instance, when the capacitive value is within a predetermined range of capacitive values within 80-90, the data analysis server assumes that a person has stepped on it. The data analysis server receives capacitive data accumulated over a period of time, for example, a day, a month or a year. The capacitive data is then sent to the database. When a user opens the access management application, the algorithm refers to the minimum and maximum value. For example, if the range of values for a particular month falls between 6000-12000, the minimum is 6000 and the maximum value is 12000, the access management application will indicate 6000 as green and 12000 as red and any value in between as yellow or orange depending on how close they are to the extremes.

A database for storing the sensor data including but not limited to the capacitive data and/or infrared data can be accessed on the data analysis server or the access management application. For example, the database includes storage of the following data:
1. User identifiers such as username, password and email;
2. User Wifi Settings;
3. Code versions of each controller (To determine if OTA updates are required);
4. Security Status of the tile;
5. The various tiles (Tile 1, Tile 2 . . . ) and the various capacitive values for each tile;
6. Favourite devices for each user (Give app users a quick access to their favourite devices enabling them to turn on the devices quickly without much navigation).

As used herein, a database may store the aforesaid data to and access data from a single stand-alone computer, a laptop, a tablet, a data server, multiple dedicated data servers, a cloud-based service, and/or a virtual server running on a network of servers. As discussed in the description, the use of the term “database” indicate a collection of tables, records, and/or linkage information for the data records. Each database can be maintained separately and/or maintained collectively in a single database or through linkages to other database. The databases depicted in the description and figures can be on the same server or on separate servers. Data records of the capacitive data and infrared data can be stored in one database or linked between separate databases.

In some embodiments, the event analysis module allows the user to filter footfall activity based on predetermined time periods. In some embodiments, the footfall activity can be generated by hours, day, month or year. Each corresponding time period indicates the total footfall activity generated within the corresponding time period. In some embodiments, the map analysis module allows the user to filter footfall activity based on footfall activity, for example, high traffic areas or low traffic areas. This allows the user to immediately identify the high and low traffic areas within the floor layout for easy identification and planning purposes. The high and low traffic areas can be color coded based on footfall activity for easier identification.

### Fire Detection

As mentioned above, an infrared sensor located on the base assembly is configured to provide data indicative of one or more of color or intensity of light impinging thereof. For example, the infrared sensor may include infrared detectors that can detect thermal radiation and is sensitive to a variation of radiation at selected wavelengths. In some embodiments, the infrared detectors may include a pyroelectric sensor. The optical sensor provides infrared data capable of detecting sudden changes in temperature which may be indicative of a fire occurring within a specific range.

In some embodiments, the infrared sensor is configured to generate infrared data upon detection of changes in thermal radiation. The infrared data generated can be binary, for example, either a 1 or 0 is generated. If a fire is detected, the infrared sensor generates infrared data indicative of a fire and sends the infrared data (for example, a1) to the controller and the data analysis server which then sends out an alert to the user in the form of message/email or even an automated voice call

### Inventory Tracking of Items/Humans

The access management application includes tracking modules for tracking of inventory or humans equipped with one or more tags for tracking purposes within a facility. The modules include a live tracking module or an inventory module. A user can configure the surface covering devices within a floor layout to either track humans or inventory or both. The humans or the objects can be equipped with one or more tags. The tags may be configured to emit a signal upon a stimulus for a RFID reader to send a read signal to the tags. In one implementation, upon detection of change in capacitive values from the capacitive sensors, this will trigger activation of a RFID reader located on the tile to send a read signal whereupon the RFID sensor emits a tag signal in the form of a radiofrequency (RF) signal that is received by the RFID reader. In another implementation, the tag may comprise a transmitter and a power source configured to power the transmitter. For example, the tag may include a Bluetooth Low Energy (BLE) transmitter and battery.

The tracking modules may be configured to use the RFID sensors (or tags) for one or more of identification of the human or object and determining a location of the human or object. For example, the users may wear tags, the objects may have tags affixed, which may be read by the RFID reader, based at least in part on signal strength, used to determine identity and location based on the capacitive values from the capacitive sensors. In some embodiments, the RFID reader located in the surface covering device may be an active transmitter that continuously scans its surroundings for RFID tags and receives a signal from the RFID tag, for example, a tag identifier, when in proximity with the RFID tag. The tag identifier is then sent to the controller and database for updating. The RFID reader is positioned between the top surface of the tile and the base assembly. Any number of RFID readers can be used.

In some implementations, a RFID reader is embedded within a surface covering device and forms a group of RFID readers when it is arranged on the floor layout of the facility. Each RFID reader is configured to receive a tag signal from the RFID tag when any change in capacitive data is detected. When a RFID reader receives the tag signals from one or more RFID tags, it generates a tag identifier that is sent to the sensor controller. The tag identifier and the capacitive data are transmitted to the data analysis server for determination of the event. The data analysis server identifies the object or human associated with the tag signal and capacitive data associated with the location of the surface covering device relative to the floor layout. In some implementations, when a tagged user or a tagged object carried by a user walks on the surface covering devices, the sensor controller receives the tag identifier associated with the user or the object and updates the database. A location identifier indicative of a position of one or more adjacent surface covering devices relative to the floor layout can be generated. The location identifier can be generated based on the tag identifier and the capacitive data. The location identifier is associated with the location of the surface covering device within the layout and provides the last known location of the user or object on the floor layout. The event analysis module can identify events within the facility by monitoring the tag identifiers and the location identifier received with more accuracy, and for more events, in real time or substantially in real time.

In some implementations, the location identifier include at least one distance indication, or some combination thereof. A location identifier is configured by the user and may include, for instance, a room number in an office building or hotel, a store name in a mall, a room description such as “first floor toilet” or “threshold between kitchen and family room” in a residential, one or more coordinates (e.g., GPS coordinates or local building map coordinates), or some combination thereof. A distance indication may include, for instance, a distance to a building structural feature, such as a vertical building structural feature like a wall or a door (e.g., 10 feet to front door), a spatial building structural feature like a room or an area, a known geospatial or building mapping coordinate. The location identifier may further include a directional indication, including separately or as part of a distance indication. Additionally or alternatively, the location identifier stored by the location sensor may include descriptive details of a building, such as stairs, door, elevator, or specific rooms (e.g., kitchen, office, or bathroom), including a distance or a direction thereto. In some implementations, the user can configure the tag identifier and the location identifier accordingly in the access management application. For example, instead of “xyz was last seen over tile 2”, the event analysis module can determine the event as “tile 2 is the middle of the kitchen”. Hence the message or alert provided to the user read as “object xyz was last seen in the middle of the kitchen”

TABLE 2

| Timestamp | RFID Tag | Tile | |
|---|---|---|---|
| Identifier | Identifier | Number | Tile Location Data |
| 0900 | RF8588 | Tile 1 | Office Entrance |
| 0901 | RF8588 | Tile 20 | Lift Lobby |
| | | | (Level 1) |
| 0902 | RF8588 | Tile 45 | Wing A Corridor |
| 0903 | RF8588 | Tile 67 | Pantry |
| 0904 | RF8588 | Tile 67 | Pantry |
| 0905 | RF8588 | Tile 80 | Meeting Room |

From the above table, from 0900 to 0903, person A (ID: RF8588) went from Tile 1 to Tile 67. He then remained on tile 67 for 1 minute before heading to Tile 80. In some embodiments, the speed of person A can be derived based on the data collected. For instance, from the above mentioned data, we can see that person A (ID: RF8588) walked with high speeds from Tile 20 to Tile 45 but walked pretty slowly from Tile 67 to Tile 80.

### Electronic Appliance Control

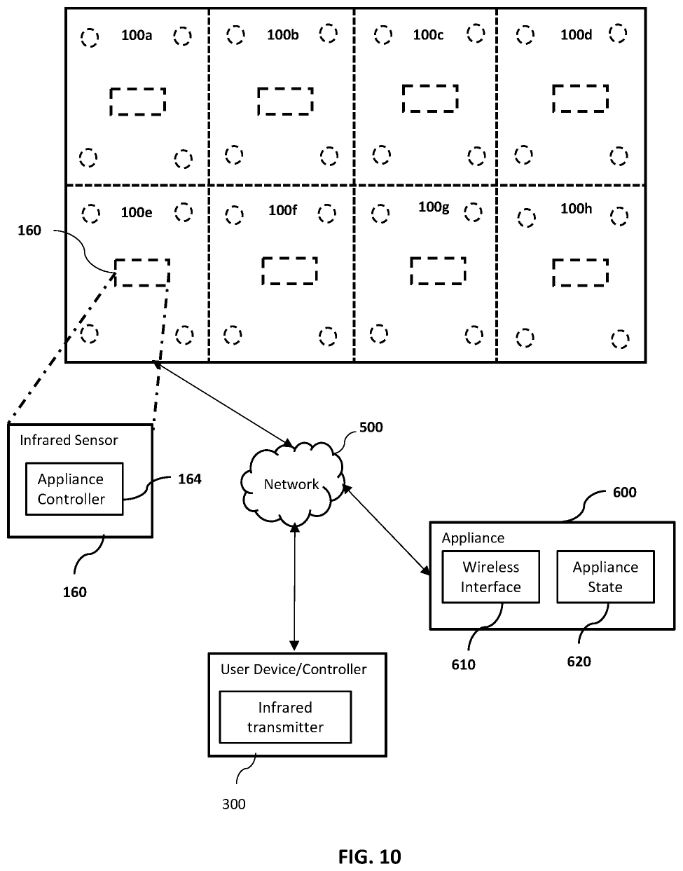

FIG. 10 illustrates generally an example embodiment of an appliance module for controlling an electronic appliance 600. The access management application includes an appliance module 363 that is configurable by the user for remotely controlling the activation state of an electronic appliance on a predetermined event detected on the surface covering device. The surface covering devices 100a-100h, which is illustrated as a floor covering in FIG. 10, may cover partially or fully a facility or a room, and each surface covering device includes an infrared sensor 160, which is visible for purposes of explanation but may instead be hidden within or embedded within the removable tile. In one or more example embodiments, the infrared sensor 160 includes at least one appliance controller 164. The appliance controller 164 may be stored in a storage memory (not shown) of a processor (not shown) of the infrared sensor 160. Although not shown, the infrared sensor 160 may also store a unique identifier, such as a set of alphanumeric characters, corresponding to the infrared sensor thereof.

In some embodiments, the infrared sensor 160 is embedded within the surface covering device and forms a group of infrared sensors 160 when it is arranged on the floor layout. Each infrared sensor 160 is configured to receive infrared signals when the said signals are within proximity of the infrared sensor.

In some embodiments, the infrared sensor is configured to control an electronic appliance that is remotely located from the surface covering device. The infrared sensor 160 includes an appliance controller 164. In some implementations, the infrared sensor 160 is an infrared receiver for receiving infrared signals from an infrared transmitter associated with an electronic appliance 600. The electronic appliance 600 includes a wireless interface 610 and an appliance state 620. In operation, a person walks across the floor covering, and the infrared signal is transmitted by, for example, the infrared transmitter. The infrared transmitter can be a user device 300 or a controller device for controlling an electronic appliance 600. Examples of the electronic appliance 600 include a thermostat, a television, an air conditioning unit, a fan, a security device, a light bulb, a light fixture or kit, a sound source, and an electrical outlet. The appliance 600 includes a wireless interface 610 and at least one appliance setting 620. The wireless interface 610 enables the appliance 600 to wirelessly communicate with the user device 300, the infrared sensor 160, a remote website or cloud service via a Wi-Fi access point (not shown), an infrared signal or a control signal.

The appliance state 620 effectively establishes a state of operation for the appliance 600. Changing the appliance state 620 changes the state of the corresponding appliance 600. The appliance state 620 may vary by appliance. A thermostat, for instance, may have an on/off or a temperature setting. A sound source may have a volume level, a speaker designation, a streaming account, or a playlist setting. A light bulb may have an on/off, a color, or a luminosity setting. The appliance 600 is capable of receiving a control signal from the appliance controller 164 wirelessly via the wireless interface 610. The appliance 600 processes the received control signal, interprets the control signal as an instruction to change the appliance state 620, and establishes the corresponding appliance state 620 to achieve the desired or requested appliance state.

In order to provide a relevant control signal for the electronic appliance 600, the infrared sensor 160 in the base assembly 105 is first configured with an appropriate control signal. In an implementation, the user device 300 is a mobile device that is installed with a software application that includes predetermined control signals from various manufacturers of electronic appliances for the purpose of controlling the electronic appliances through the predetermined control signals. Similarly, the controller of the base assembly includes a database that includes predetermined control signals from various manufacturers of electronic appliances for the purpose of controlling the electronic appliances through the predetermined control signals. In one implementation, the user device provides a means for using an app for the targeted electronic appliance 600, contacting a website of the manufacturer of the targeted electronic appliance 600, or some combination thereof in order to obtain the first control signals or desired control signals.

### Display Interface for General Purposes

The surface covering device 100 also comprises a display interface 131 arranged to output visual imagery. The display interface 131 may include an LED, Organic LEDs, LCD, or include any type of suitable forward or rear projection technology, or any other known visual output technology. The display interface 131 may cover a section of, or the entirety of, the surface covering device 100, to enable visual content to be displayed on a section or the entirety of the display screen. The display interface 131 is positioned within the tile and the visual content displayed on the display screen is shown through the removable tile.

The display interface is in data communication with the controllers 110, 120, 130. The display interface includes an input (not shown) arranged to receive visual data from one or more of the controllers 110, 120, 130. The controllers are configured to receive visual data from the access management application and cause it to be displayed on the display interface. As previously mentioned, the display interface 131 is configured to display a plurality of visual indicators. The display interface 131 provide visual indicators that are visible through the removable tile 106 and provide useful information of the status of the surface covering device 100 to the user for making decisions pertaining to the condition of the surface covering device 100. The visual indicators include but are not limited to battery status indicator, controller status indicator 132, network connectivity status indicator 134, mesh connectivity status indicator 132, and calibration status indicator 133. The display interface 131 may further comprise a memory (not shown). The memory may be any type of volatile or non-volatile memory that is suitable for storing data for later retrieval. The memory may receive visual data from the processor 108, and store at least part of the visual data for later retrieval by the controller 110 during playback of the visual content.

### Gaming

The access management application includes a gaming module that is activated by the user for selecting a plurality of game options on the surface covering device. The surface covering devices 100a-100h, which are illustrated as a floor covering in FIG. 8, may cover partially or fully a facility or a room, and each surface covering device includes capacitive sensors. In an implementation, each surface covering device measures 2 m×2 m, and includes a plurality of capacitive sensors on each surface covering device. The capacitive sensors and its associated capacitive pads are spaced equally apart on the surface covering device in rows and columns and are spaced such that a user that steps on the surface covering device will contact at least one capacitive pad.

The user accesses the gaming module on the application and selects a game (for example, whack-a-mole, Snake or Tetris) from a plurality of gaming options. The signal is transmitted and received by the data analysis server to be transmitted to the controller of the base assembly. The game mode allows a user to play a game on the surface covering device by using the plurality of capacitive sensors and its associated capacitive pads as a means for communicating instructions to the controller and the display screen on the surface covering device. The capacitive sensors are buttons for the user to step on for sending instructions to the controller and creating an action on the display panel based on the activation of the button. During operation, the user is instructed by the gaming module on how to play the game. For example, the instructions are to place your foot on a predetermined section of the surface covering device for sending a specific instruction to the game. For example, stepping on the predetermined section of the surface covering device will cause the actor in the game to turn right, and stepping on another predetermined section of the surface covering device will cause the actor in the game to turn left.

The display panel will partially cover the surface covering device and, in some implementations, the dimensions are around 0.5 m to 1 m of a 2×2 m surface covering device. The LED will shine through the top tile segment. Hence the top tile segment would still be removable

In some implementations, the surface covering devices can be interconnected to form a larger display screen for playing games. The surface covering devices can be interconnected to each other through the data analysis server. The display screens of each surface covering devices can be coordinated with one another and controlled by a single controller of one surface covering device that allows multiple surface covering devices to seamlessly connect with one another to play games.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

Since the mesh controller is connected to the infrared controller and sensor controllers that are in turn connected to the network, users can choose to turn on or off electronic appliances or devices from the access management application. Below is a general flow for what happens when Jim wants to turn on a lightbulb in his room.

Jim Presses the ‘On’ button in the application→A control signal is sent to the database in the server→the infrared controller and the capacitive controller which are both connected to the network periodically check for updates from the database in the server.→When the infrared controller and capacitive controller detects the control signal for the request for light to be on.→The control signal is then sent to the mesh controller using serial communication→The mesh controller then blasts out a control request or a JSON message that is received by nearby mesh controllers→the nearby mesh controllers repeats or echo out this control request or command/JSON message until it reaches the target mesh controller→The target mesh controller then turns on the light bulb.

While the above process stated above may be tedious and seem very long, it happens under 3 seconds. Note that only either the infrared controller or the capacitive controller can be connected to the network and hence access data from the database. The mesh controller is unable to connect to the network as it needs to create its own network architecture.

### How the Mesh Controller, Capacitive Controller and Infrared Controller Work Together

Scenario 1. Jim Wakes up in the morning and gets up from bed and touches the floor. This is detected by the capacitive sensors which relays this information to the infrared controller. The infrared controller blasts the infrared signal for turning off the aircon which turns off the aircon. Concurrently, the mesh network turns on the coffee maker for Jim.

Hence, the combination of capacitive controller, mesh controller and infrared controller can assist users with their daily life routines.

Scenario 2. Mall/Home Toilets. Jim finishes showering and leaves the toilet in a hurry and forgets to turn off the heater and the lights. However, the capacitance sensor detects that no one is in the toilet and hence turns off the heater and light for Jim. In the mall toilets, the capacitance sensors can detect if anyone is still in the toilet and instruct the mesh network to turn on or off all the lights and exhaust fan. Capacitance sensors are far better than a Passive Infrared Sensor (PIR) sensors as a person sitting in the cubicle may not be detected by motion or PIR sensors and hence a possibility that the lights can turn off with a person inside.

Scenario 3. Office Setting. While many newer model of air cons come with IoT features, air cons are an expensive investment to many and hence many may stick to older models of aircon. Let's say the break room in an office building is vacant, this will be detected by the capacitance sensor and triggers the infrared controller to send control signals to turn off the Air-conditioning and TVs in the room.

Scenario 4. Elderly Home. Elderly can be tagged with RFID stickers to track their movement in a manner that respects their privacy. However, continuous scanning is an energy intensive process. Therefore, the RFID reader will only be activated when footsteps are detected or when a change in capacitance values are detected. Moreover, in the situations of a fall, we want to know who has fallen so that we can contact their closest kin. Hence, when the capacitive sensors detect a fall, it triggers that RFID reader to identify who has fallen and can inform relevant authorities that Mr Kim has fallen. This would be impossible with only capacitive sensor alone.

Scenario 5. Healthcare. Patients who are very ill may accidently fall out of bed or may hallucinate and venture out into dangerous areas. This can easily be detected by the capacitance sensors that can then send alerts via the mesh controller to page the nurses or ring an alarm to indicate a critical situation.

Scenario 6. Retail. In large retail stores, it is expected to see not all aisles being filled with patrons. Hence, using the combination of capacitance and mesh, we can dim the lighting over the area or run any other electrical devices such as fan at half power.

Scenario 7. Mall Ac Management. In a mall, not all levels/sectors maybe filled with patrons especially when the mall is huge. Hence, the capacitance sensors can act as an good gauge to detect the traffic and can work with the mesh network to change the temperature/status of aircon. For instance, in high foot traffic areas, the capacitance-mesh/IR combo can set the Ac temperature to 24 degrees while in 0 foot traffic ideas, the AC can be off completely.

Scenario 8. Sales Data. Assuming the clothes have RFID tag attached on it, we can activate the RFID scanner whenever people walk by thereby learning and analyzing the current trends, At the end of the day, not only can we generate a foot map but also give sales insight into which clothes users are choosing.

Scenario 9: A combination of RFID scanner, a capacitive sensor and a capacitive controller and a mesh controller that are located on surface covering devices at access control points, for example, at a gantry in a subway station can be configured for opening and closing the gantry for access when a user walk towards the gantry. The RFID tag on the user is responsible for charging the customers and the mesh controller within the surface covering device is responsible for opening the gantry. This can significantly reduce crowding along the gantry and ensure smoother flow of human traffic. In the platform itself, capacitive data obtained from the capacitive sensors can be used to help consumers move to less crowded area along the platform.

Scenario 10: Access Control can be performed in large events held at a large conference facility or a school where only authorised people (for example, registered conference attendees, teaching staff, teachers or students) can enter the event. This is achieved through the use of RFID scanners, mesh controller, capacitive sensors and controllers located in surface covering devices at the access control points. When a person approaches a gantry where the surface covering device is located, for example at the entrance of the facility or school, the capacitive sensor within the tile will trigger the RFID scanner which will scan the person's RFID tag and only open the gantry via mesh when the RFID tag ID is valid for the event (in the nominal roll). Events can also include football matches. It can also include theme parks, museums or anywhere that requires access control.

Scenario 11: The combination of capacitive sensors, a capacitive controller and a mesh controller can also be utilized in car parks. The capacitive sensors, capacitive controller and mesh controller are located within surface covering devices near the access control point of a car park facility. Cars can be detected by capacitive sensor in the surface covering device due to their large metal chassis which is conductive. This information can be relayed to an LCD screen via the mesh network that can display the available car park slots in every level and lane. This would significantly cut down the time taken for drivers to find a parking slot.

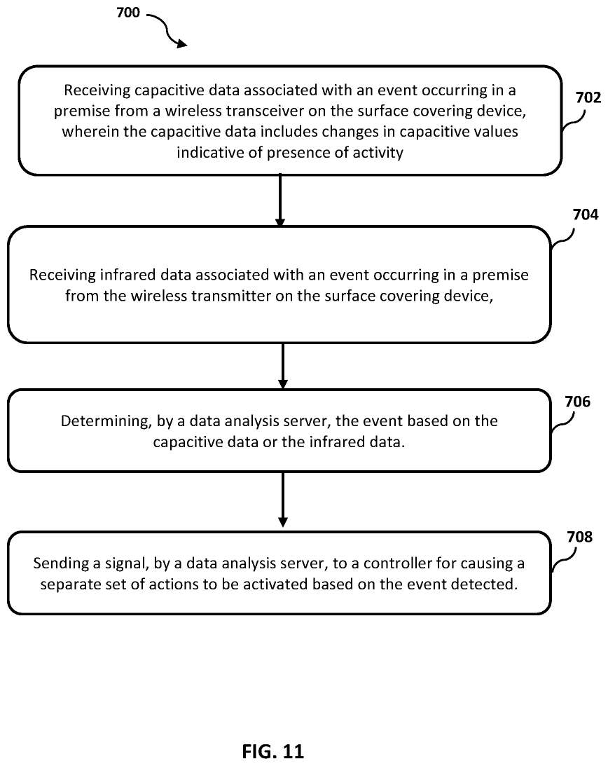

FIG. 11 depicts a flowchart for a method for detecting an event according to some embodiments of the invention. In FIG. 11, the flowchart 700 begins at processing block 702 where a data analysis server receives receives capacitive data associated with an event occurring in a premise from a wireless transceiver on the surface covering device, wherein the capacitive data includes changes in capacitive values indicative of presence of activity. The capacitive data is generated by the surface covering device whenever there is a change in capacitive values detected in the capacitive sensor, for example, when someone steps on a tile.

At step 704, the data analysis server 200 receives infrared data associated with an event occurring in a premise from the wireless transmitter on the surface covering device.

In step 706, the data analysis server, or the access management application, will determine the event which is associated with one or more predetermined range of capacitive values. The one or more predetermined range of capacitive values is indicative of a predetermined pattern of activity as mentioned above. For instance, a range of capacitive values within 80-90 indicate activity associated with footfall. For instance, a range of capacitive values above 95 indicate activity associated with fluid presence on the tile. For instance, a range of capacitive values<50 indicate activity associated with a heavy impact or fall. The types of event determined includes but not limited to, footfall patterns, falls, fire detection, electronic appliance control, etc.

In step 708, the data analysis server will cause a signal to be communicated to a user device based on the event detected. The signal will then cause a separate set of actions to be activated. The set of actions could range from activating a notification to be communicated to a user device or activating a state of an electronic appliance from on to off or vice versa.

In some embodiments, when the capacitive values fall within the capacitive values associated with footfall activity, the infrared sensor transmits one or more control signals configured to be received by one or more electronic appliances, wherein the one or more control signals are configured for controlling an activation state of the electronic appliances.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A surface covering device comprising:
a tile;
a base assembly,
a plurality of tile connectors located between the tile and the base assembly for releasably connecting the tile to the base assembly,
at least one capacitive sensor located on the tile, wherein the at least one capacitive sensor includes a plurality of capacitive pads that extends outwardly from the capacitive sensor to cover a section of the tile, and the capacitive sensor is configured to detect changes in capacitive data indicative of the presence of activity within a predetermined range of the capacitive sensor;
an infrared sensor configured to receive infrared data;
a capacitive controller communicatively coupled to an infrared controller configured for receiving the capacitive data and the infrared data from the capacitive sensor and infrared sensor respectively;
a mesh controller configured to receive the capacitive data and the infrared data from the capacitive controller and infrared controller respectively,
a wireless transceiver in data communication with the capacitive controller and the infrared controller, wherein the wireless transceiver is configured to transmit the capacitive data and the infrared data to a data analysis server, wherein the data analysis server is configured to determine an event based on the capacitive data and the infrared data.

2. The surface covering device according to claim 1, wherein each capacitive pad detects changes in capacitive values indicative of presence of activity within range of the capacitive pad.

3. The surface covering device according to claim 1, wherein the event is associated with one or more predetermined range of capacitive values wherein each one of the one or more predetermined range of capacitive values is indicative of a predetermined pattern of activity.

4. The surface covering device according to claim 2, wherein the event is defined by capacitive values falling within a first predetermined range of capacitive values that is associated with footfall activity.

5. The surface covering device according to claim 4, wherein when the capacitive values fall within the first predetermined range of capacitive values associated with footfall activity, the infrared sensor transmits one or more control signals configured to be received by one or more electronic appliances, wherein the one or more control signals are configured for controlling an activation state of the electronic appliances.

6. The surface covering device according to claim 5, wherein the infrared sensor includes an appliance controller capable of storing the one or more control signals.

7. The surface covering device according to claim 2, wherein the event is defined by capacitive values falling within a second predetermined range of capacitive values that is associated with presence of a fluid on the tile.

8. The surface covering device according to claim 2, wherein the event is defined by capacitive values falling within a third predetermined range of capacitive values that is associated with a fall of a human on the tile.

9. The surface covering device according to claim 7, wherein when the capacitive values fall within the second or third predetermined range of capacitive values, the data analysis server is configured for communicating via a network with a user device to output an alert of the event associated with the activity associated with the second or third predetermined range of capacitive values.

10. The surface covering device according to claim 1, wherein the infrared sensor is configured for receiving a control signal from a user device, wherein the control signal controls the activation state of an electronic appliance.

11. The surface covering device according to claim 1, wherein the infrared sensor is configured for detecting changes in temperature of the surroundings, wherein a temperature detected above a threshold temperature is indicative of a fire.

12. The surface covering device according to claim 1, further comprising a controller board for mounting the mesh controller, capacitive controller and infrared controller.

13. The surface covering device according to claim 2, wherein the capacitive values received by the capacitive controller is indicative of a position of the surface covering device relative to adjacent surface covering devices within a premise.

14. The surface covering device according to claim 4, further comprising an RFID reader configured to be activated to receive RFID signals from an RFID sensor attached to a human or object when the capacitive values fall within the first predetermined range of capacitive values associated with footfall activity.

15. The surface covering device according to claim 14, wherein the RFID signals include a tag identifier associated with the human or object.

16. The surface covering device according to claim 1, further comprising a display interface in data communication with capacitive controller, the infrared controller and the mesh controller, wherein the display interface includes visual indicators visible through the tile.

17. The surface covering device according to claim 1, wherein the visual indicators include one or more of the following: a controller status indicator, network connectivity status indicator, mesh connectivity status indicator and calibration status indicator.

18. The surface covering device according to claim 1, wherein the base assembly further comprises one or more power connectors located at two edges of the base assembly.

19. A method for determining an occurrence of an event, the method performed by an access management application on a user device in communication with a surface covering device, comprising the steps of:
receiving capacitive data associated with an event occurring in a premise from a wireless transceiver on the surface covering device, wherein the capacitive data includes changes in capacitive values indicative of presence of activity;
receiving infrared data associated with an event occurring in a premise from the wireless transmitter on the surface covering device,
determining, by a data analysis server, the event based on the capacitive data or the infrared data;
sending a signal, by a data analysis server, to a controller for causing a separate set of actions to be activated based on the event detected.
